(19) United States
(12) Patent Application Publication
(10) Pub. No.: US 2002/0170395 A1
(43) Pub. Date: Nov. 21, 2002

(54) Electronic type torsional wrench

(76) Inventors: Nai-Jane Wang, Taichung City (TW); John Sun, Taichung City (TW)

Correspondence Address: Charles E. Baxley, Hart, Baxley, Daniels & Holton, Fifth Floor, 59 John Street, New York, NY, 10038, US

(21) Appl. No.: 09/859,366

(22) Filed: May 18, 2001

(51) Int. Cl. B25B 23/14

(52) U.S. Cl. 81/467

(57) ABSTRACT

An electronic type torsional wrench includes a handle, a force applying stem, a drive shank, and a pressure sensor. The pressure sensor includes a base member connected with the force applying stem, and a detecting member connected with the drive shank. In such a manner, when the relative pressure is formed between the force applying stem and the drive shank, the pressure sensor detects pressure values which are converted into torsion reading values by the converting unit, and the torsion reading values are displayed by the display monitor. Thus, the torsion reading values can be detected accurately, and the operation of the torsional wrench is convenient.

### BACKGROUND OF THE INVENTION

1. Field of the Invention

The present invention relates to an electronic type torsional wrench, and more particularly to an electronic type torsional wrench including a pressure sensor for detecting the torsion of the wrench, and an electronic circuit for converting the pressure values into torsion reading values.

2. Description of the Related Prior Art

A first conventional torsional wrench in accordance with the prior art shown in FIG. 1 comprises a drive shank 10 having a first end formed with a drive head 11 and a second end pivoted with a handle 14 by a pivot point 15, a torsion scale 13 is secured on the drive shank 10 adjacent to the handle 14, and a pointer rod 12 integrally extended from the drive head 11 and having a free end pointed to the torsion scale 13. Under the normal state, the pointer rod 12 is in parallel with the drive shank 10.

In operation, the drive head 11 is fitted on a workpiece. The operator then exert a force on the handle 14 rotate the wrench and operate the workpiece. The handle 14 is pivoted with the drive shank 10 by the pivot point 15 so that the force in each direction exerted by the operator on the handle 14 can be concentrated on the pivot point 15 to be transmitted to the wrench. Thus, when the force applied on the wrench exceeds a predetermined value, the pointer rod 12 deflects the drive shank 10 through a relative angle, so that the pointer 120 of the pointer rod 12 can indicate the torsion exerted on the wrench by the deflecting angle between the pointer rod 12 and the drive shank 10.

However, the first conventional torsional wrench has the following disadvantages.

1. The operator has to exert a torsional force on the handle successively so that the pointer of the pointer rod can read the torsion values. Thus, the torsion reading values are not accurately because the successive force applied by the operator is not even.

2. The pointer rod protrudes from the drive shank, so that it is easily hit, thereby affecting the accuracy thereof.

3. The operator has to exert a torsional force on the handle successively so that the pointer of the pointer rod can read the torsion values, thereby wasting the operator's energy.

A second conventional torsional wrench 16 in accordance with the prior art shown in FIG. 2 is disclosed in the Taiwanese Patent Publication No. 288375. The output torsion of the torsional wrench 16 is adjustable. When the force applied on the wrench exceeds a predetermined value, the wrench idles, thereby limiting the torsion exerted by the operator. However, the torsional wrench 16 cannot clearly indicate the torsion reading values.

### SUMMARY OF THE INVENTION

The present invention has arisen to mitigate and/or obviate the disadvantage of the conventional torsional wrenches.

The primary objective of the present invention is to provide an electronic type torsional wrench, comprising:

a drive shank;

a handle mounted on one end of the drive shank; and

an electronic type pressure sensor mounted between the drive shank and the handle;

wherein, when a relative pressure is formed between the drive shank and the handle, the pressure sensor detects pressure values, and displays torsion reading values.

In accordance with the present invention, there is provided an electronic type torsional wrench, comprising:

a handle, having an inside formed with a hollow receiving chamber;

a force applying stem, mounted in the receiving chamber of the handle, and pivoted with the handle by a pivot point, the force applying stem having one end formed with a combination portion;

a drive shank, having a first end formed with a drive head, and a second end combined with the combination portion of the force applying stem; and

a pressure sensor, mounted between the drive shank and the handle, and including a base member, a detecting member, a converting unit, and a display monitor, the base member mounted on the force applying stem, and the detecting member mounted on the drive shank;

wherein, when a relative pressure is formed between the force applying stem and the drive shank, the pressure sensor detects pressure values which are converted into torsion reading values by the converting unit, and the torsion reading values are displayed by the display monitor.

The combination portion of the force applying stem is formed with two combination points, and the second end of the drive shank is formed with a connecting portion combined with the two combination points of the combination portion of the force applying stem.

Preferably, the pressure sensor indicates by blink of light signals that a predetermined torsion value is reached.

Alternatively, the pressure sensor indicates by audio signals that a predetermined torsion value is reached.

Further benefits and advantages of the present invention will become apparent after a careful reading of the detailed description with appropriate reference to the accompanying drawings.

### BRIEF DESCRIPTION OF THE DRAWINGS

FIG. 1 is a top plan schematic view of a first conventional torsional wrench in accordance with the prior art;

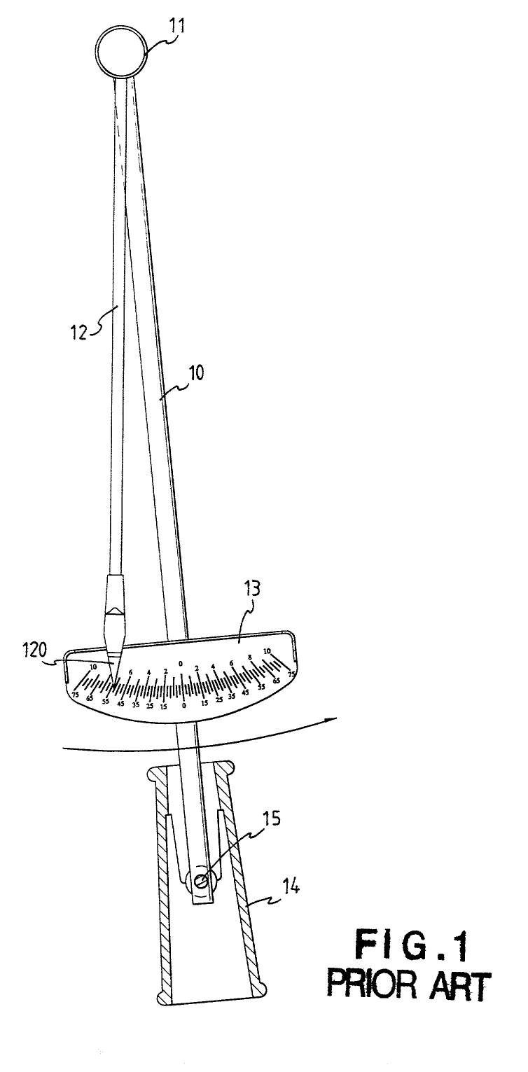

FIG. 2 is a perspective view of a second conventional torsional wrench in accordance with the prior art;

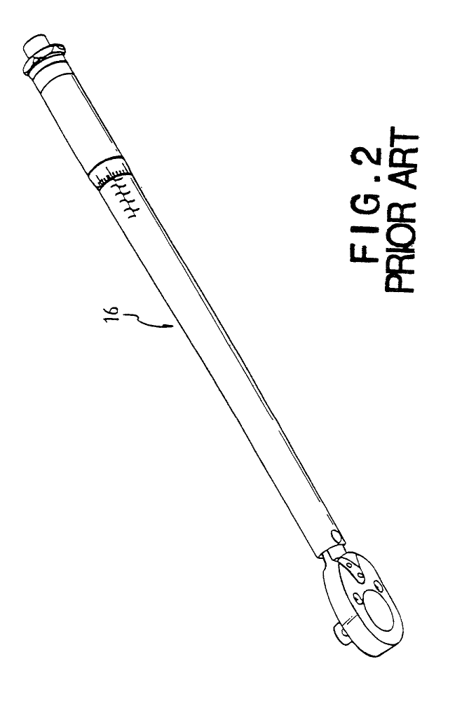

FIG. 3 is a perspective view of an electronic type torsional wrench in accordance with the present invention; and

FIG. 4 is a partially cut-away cross-sectional view of the electronic type torsional wrench as shown in FIG. 3.

### DETAILED DESCRIPTION OF THE INVENTION

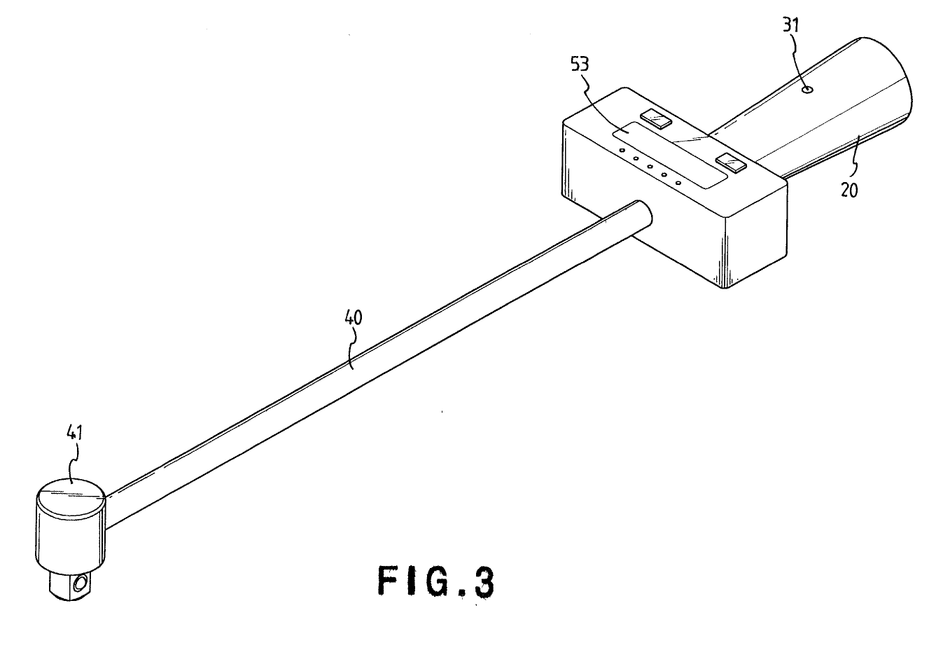

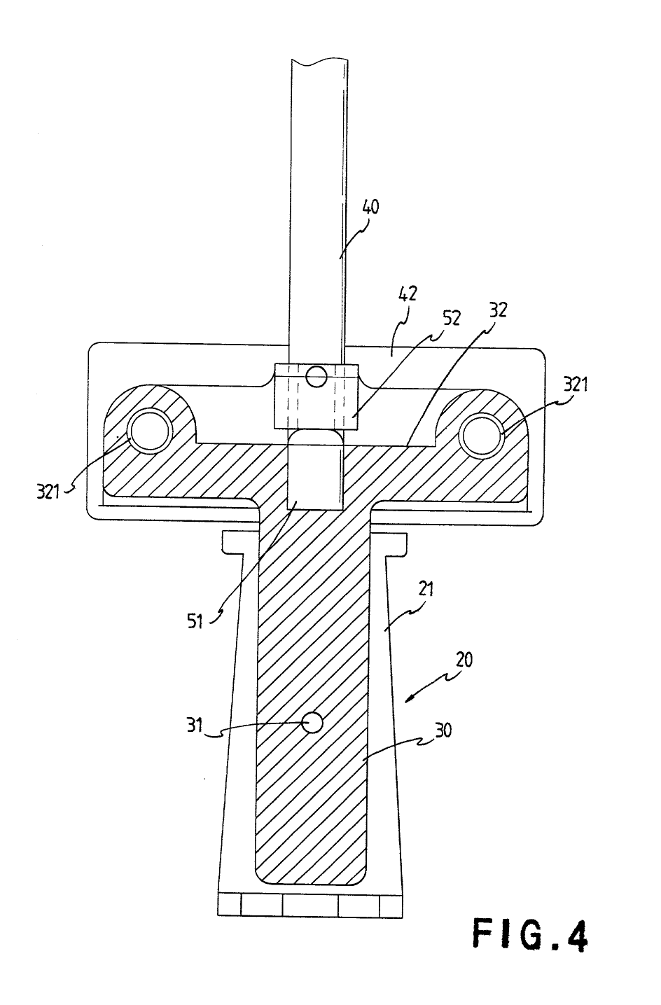

Referring to FIGS. 3 and 4, an electronic type torsional wrench in accordance with the present invention comprises a handle 20, a force applying stem 30, a drive shank 40, and a pressure sensor 50.

The operator may hold the handle 20 to exert a force thereon. The handle 20 has an inside formed with a hollow receiving chamber 21.

The force applying stem 30 is mounted in the receiving chamber 21 of the handle 20, and is pivoted with the handle 20 by a pivot point 31, so that the handle 20 can swing on the force applying stem 30. Thus, the force in each direction exerted by the operator on the handle 20 can be concentrated on the pivot point 31 to be transmitted to the force applying stem 30. The force applying stem 30 has one end formed with a combination portion 32.

The drive shank 40 has a first end formed with a drive head 41 such as a socket head, a wrench head or the like, and a second end combined with the combination portion 32 of the force applying stem 30.

The combination portion 32 of the force applying stem 30 is formed with two combination points 321. The second end of the drive shank 40 is formed with a connecting portion 42 combined with the two combination points 321 of the combination portion 32 of the force applying stem 30.

The pressure sensor 50 is mounted between the drive shank 40 and the handle 20, and includes a base member 51, a detecting member 52, a converting unit, and a display monitor 53. The base member 51 is combined with the force applying stem 30, and the detecting member 52 is combined with the drive shank 40, and vice versa.

By such an arrangement, when a relative pressure is formed between the force applying stem 30 and the drive shank 40, the pressure sensor 50 detects the pressure values which are converted into torsion reading values by the converting unit (the converting unit may be a circuit converting unit), and the torsion reading values are displayed by the display monitor 53 in various numbers.

It is appreciated that, the torsional wrench in accordance with the present invention primarily employs the “variation of pressure” between the force applying stem 30 and the drive shank 40 to serve as value detection, so that the torsional wrench can obtain accurate detecting values.

In use, the operator may directly read the torsion reading values from the display monitor 53. When the torsion reading values are detected, the data of the torsion reading values are indicated on the display monitor 53, so that the operator needs not to exert the force successively. In addition, the operator can preset the torsion values through the design of a circuit, so that when the wrench is rotated to reach the predetermined torsion value, the pressure sensor 50 not only displays the reading values through the display monitor 53, but also informs the operator that the predetermined torsion value has been reached by means of blink of light signals or by audio signals, so that the operation is convenient.

According to the torsional wrench of the present invention, the force applying stem and the drive shank of the wrench are respectively combined with the base member and the detecting member of the pressure sensor. Thus, when the relative pressure is formed between the force applying stem and the drive shank, the pressure sensor detects pressure values which are converted into torsion reading values by the converting unit, and the torsion reading values are displayed by the display monitor. Therefore, the torsion reading values can be detected accurately, and the operation of the torsional wrench is very convenient.

While the preferred embodiment of the present invention has been shown and described, it will be apparent to those skilled in the art that various modifications may be made in the embodiment without departing from the spirit of the present invention. Such modifications are all within the scope of the present invention.

What is claimed is:

1. An electronic type torsional wrench, comprising:
a drive shank (40);
a handle (20) mounted on one end of said drive shank (40); and
an electronic type pressure sensor (50) mounted between said drive shank (40) and said handle (20);
wherein, when a relative pressure is formed between said drive shank (40) and said handle (20), said pressure sensor (50) detects pressure values, and displays torsion reading values.

2. An electronic type torsional wrench, comprising:
a handle (20), having an inside formed with a hollow receiving chamber (21);
a force applying stem (30), mounted in said receiving chamber (21) of said handle (20), and pivoted with said handle (20) by a pivot point (31), said force applying stem (30) having one end formed with a combination portion (32);
a drive shank (40), having a first end formed with a drive head (41), and a second end combined with said combination portion (32) of said force applying stem (30); and
a pressure sensor (50), mounted between said drive shank (40) and said handle (20), and including a base member (51), a detecting member (52), a converting unit, and a display monitor (53), said base member (51) mounted on said force applying stem (30), and said detecting member (52) mounted on said drive shank (40);
wherein, when a relative pressure is formed between said force applying stem (30) and said drive shank (40), said pressure sensor (50) detects pressure values which are converted into torsion reading values by said converting unit, and said torsion reading values are displayed by said display monitor (53).

3. The electronic type torsional wrench in accordance with claim 2, wherein said combination portion (32) of said force applying stem (30) is formed with two combination points (321), and said second end of said drive shank (40) is formed with a connecting portion (42) combined with said two combination points (321) of said combination portion (32) of said force applying stem (30).

4. The electronic type torsional wrench in accordance with claim 2, wherein said pressure sensor indicates by blink of light signals that a predetermined torsion value is reached.

5. The electronic type torsional wrench in accordance with claim 2, wherein said pressure sensor indicates by audio signals that a predetermined torsion value is reached.
